(19) United States
(12) Patent Application Publication
(10) Pub. No.: US 2025/0131848 A1
(43) Pub. Date: Apr. 24, 2025

(54) SYSTEM AND METHOD FOR SKILL PROFILING

(71) Applicants: Ashish MEHTA, Gurgaon (IN); Ananta Basudev MAHAPATRA, Bengaluru (IN)

(72) Inventors: Ashish MEHTA, Gurgaon (IN); Ananta Basudev MAHAPATRA, Bengaluru (IN)

(21) Appl. No.: 18/277,790

(22) PCT Filed: Jun. 6, 2022
(86) PCT No.: PCT/IN2022/050526

§ 371 Date: Aug. 18, 2023

(30) Foreign Application Priority Data
Apr. 18, 2022 (IN) 202211022819

(51) Int. Cl. G09B 7/06; G06Q 10/0639

(52) U.S. Cl. CPC G09B 7/06; G06Q 10/06398

(57) ABSTRACT

Disclosed is disclosure provide a system and a method for skill profiling based on a multi-tier skill taxonomy. The method for skill profiling includes obtaining a first normalized skill proficiency score vector associated with a user by way of a first engine and mapping the first normalized skill proficiency score vector with a pre-set multi-tier skill taxonomy, by way of a second engine. The method for skill profiling further includes obtaining a first normalized skill score associated with the user by way of a first skill score engine and generating a first skill profile associated with the user by way of a skill profile engine. Furthermore, the method for skill profiling includes generating a second skill profile associated with the user, through update in the first skill profile associated with the user, by way of a profile update engine.

### TECHNICAL FIELD

The present disclosure generally relates to skill assessment, talent acquisition and skill profiling of a user. More specifically, the present disclosure relates to a system and method for skill profiling.

### BACKGROUND

Skill profiling has been a critical part of a recruitment process. The traditional recruitment and skill discovery methods such as employee referrals, resume screening, and face to face interviews are often subjective and vary in their evaluation of candidates based on time, resource and interviewers state of mind. A manual skill profiling and recruitment process may suffer bias in opinion of the employer and thus is not a feasible way for recruitment based on talent or skill acquisition.

State of art skill profiling systems use artificial intelligence (AI) for talent acquisition and skill profiling to overcome the bias due to personal opinion of the employer. Most of the state of art systems use AI for data acquisition and natural language processing on text extracted from a resume of a candidate to obtain skills of the candidate. As the resume is often an over-rated description of the skills, declared by the candidate himself, the recruitment must not totally rely on the self-declared skills of the candidate. In reference to the above mentioned problems, such systems also can't be relied on for an accurate skill profiling and talent acquisition.

Thus, there is a need of an advanced system and method, that facilitates a user with a reliable talent acquisition and skill profiling.

### SUMMARY

In view of the foregoing, aspects of the present disclosure provide a system and a method for skill profiling based on a multi-tier skill taxonomy.

In some aspects of the present disclosure, the method for skill profiling includes obtaining a first normalized skill proficiency score vector associated with a user by way of a first engine and mapping the first normalized skill proficiency score vector with a pre-set multi-tier skill taxonomy, by way of a second engine. The method for skill profiling further includes obtaining a first normalized skill score associated with the user by way of a first skill score engine and generating a first skill profile associated with the user by way of a skill profile engine.

In some aspects of the present disclosure, the method for skill profiling includes creating, prior to obtaining the first normalized skill proficiency score vector, a multiple-choice question (MCQ) repository having a plurality of multiple-choice questions (MCQs) such that a plurality of multiple-choice question (MCQ) responses corresponds to one or more skills of set of predefined skills stored in a skill repository.

In some aspects of the present disclosure, the method for skill profiling includes determining, prior to mapping the first normalized skill proficiency score vector with the pre-set multi-tier skill taxonomy, a correlation matrix and an inter-dependence matrix for the one or more skills of the set of predefined skills. The method for skill profiling further includes mapping a plurality of MCQ responses with the one or more skills of the set of predefined skills in accordance with the multi-tier skill taxonomy.

In some aspects of the present disclosure, to obtain the first normalized skill proficiency score vector, the method includes obtaining a first set of MCQ responses for a first set of MCQs from the user by way of a user device, and analyzing the first set of MCQ responses, to obtain the first normalized skill proficiency score vector for a first set of skills associated with the user.

In some aspects of the present disclosure, the method for skill profiling includes determining by way of the second engine, one or more first job profiles and a plurality of job positions associated with the user, based on the first normalized skill proficiency score vector.

In some aspects, the first engine is based on dense feed forward neural network and the second engine is based on sparsely connected feed forward neural network. The method for skill profiling includes obtaining the first normalized skill score by normalized weighted sur of the first normalized skill proficiency score vector. The method for skill profiling further includes generating a second skill profile associated with the user, through update in the first skill profile associated with the user, by way of a profile update engine.

In some aspects, a skill profiling system includes a user device and a server. The user device is configured to receive a plurality of multiple-choice question (MCQ) responses of a plurality of multiple-choice questions (MCQ s) from a user and display the first skill profile associated with the user based on the MCQ responses. The server coupled to the user device is configured to obtain a first normalized skill proficiency score vector associated with the user by way of a first engine. Further the server is configured to map the first normalized skill proficiency score vector with a pre-set multi-tier skill taxonomy, by way of a second engine. Furthermore, the server is configured to obtain a first normalized skill score for the user by way of a first skill score engine and generate a first skill profile associated with the user by way of a skill profile engine.

In some aspects, the server includes a multiple-choice question (MCQ) repository having a plurality of multiple-choice questions (MCQs) such that a plurality of multiple-choice question (MCQ) responses corresponds to one or more skills of set of predefined skills stored in a skill repository.

In some aspects, the server is further configured to determine, by way of the second engine one or more first job profiles s and a plurality of job positions associated with the user, based on the first normalized skill proficiency score vector. The skill profiling system includes a database coupled to the server such that the database includes a registration data repository a multiple-choice question repository, a training data repository, a skill repository, and a skill profile repository.

In some aspects, the multiple-choice question repository is configured to store a plurality of multiple-choice questions. The training data repository is configured to store a training data for the first engine and the second engine. The skill repository is configured to store a set of pre-defined skills, a first set of skills and a skill taxonomy data. The skill profile repository is configured to store and display one or more skill profiles for a plurality of users.

### BRIEF DESCRIPTION OF DRAWINGS

The drawing/s mentioned herein disclose exemplary aspects of the present invention. Other objects, features, and advantages of the aspect will be apparent from the following description when read with reference to the accompanying drawings. In the drawings, wherein like reference numerals denote corresponding parts throughout the several views:

The diagrams are for illustration only, which thus is not a limitation of the present disclosure, and wherein:

FIG. 1 illustrates a block diagram of a system for skill profiling associated with a user, in accordance with an aspect of the present disclosure;

FIG. 2 illustrates a block diagram of a server of the system of FIG. 1, in accordance with an exemplary aspect of the present disclosure;

FIG. 3 illustrates a flowchart for a method for skill profiling associated with the user, according to an aspect herein; and

FIG. 4 illustrates a flowchart of a method for updating a first normalized skill score and skill profile associated with the user, according to an aspect herein.

### DETAILED DESCRIPTION

The aspects herein and the various features and advantageous details thereof are explained more fully with reference to the non-limiting aspects that are illustrated in the accompanying drawings and detailed in the following description. Descriptions of well-known components and processing techniques are omitted so as to not unnecessarily obscure the aspects herein. The examples used herein are intended merely to facilitate an understanding of ways in which the aspects herein may be practiced and to further enable those of skill in the art to practice the aspects herein. Accordingly, the examples should not be construed as limiting the scope of the aspects herein.

Unless defined otherwise, all technical and scientific terms used herein have the same meaning as those commonly understood by one of ordinary skill in the art to which this invention belongs.

Throughout the prior art, there remains a need of a system and a method for accurate skill assessment.

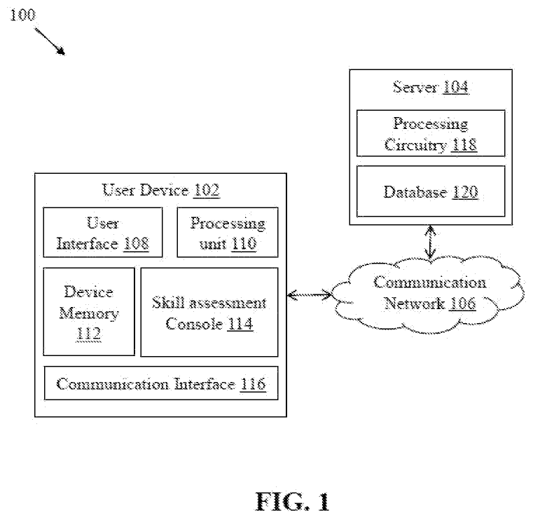

Referring initially to the drawings, FIG. 1 is a block diagram that illustrates a system (100) for skill profiling associated with a user, in accordance with an exemplary aspect of the present disclosure. The system (100) for profiling associated with the user may be configured to obtain a multi-tier skill taxonomy including a set of pre-defined skills. Further, the system (100) may be configured to obtain a first normalized skill score and create a first skill profile associated with the user.

Aspects of the present disclosure are intended to include and/or otherwise cover any type of multi-disciplinary pre-defined skills corresponding to multi-tier skill taxonomy. In some aspects, one or more skills may be added to the pre-defined skills. In some aspects, the multi-tier skill taxonomy may be altered based on one or more skills added to the set of pre-defined skills.

In an aspect of the present disclosure, the system (100) may include a user device (102) and a server (104). The user device (102) and a server (104) may be communicatively coupled to each other via a communication network (106). In other aspect of the present disclosure, the user device (102) and the server (104) may be communicably coupled through separate communication networks established therebetween.

The user device (102) may be configured to facilitate the user to input data, receive data, and/or transmit data within the system (100). Examples of the user device (102) may include, but are not limited to, a desktop, a notebook, a laptop, a handheld computer, a touch sensitive device, a computing device, a smart-phone, and/or a smart watch. It will be apparent to a person of ordinary skill in the art that the user device (102) may include any device/apparatus that is capable of manipulation by the user.

In an exemplary aspect of the present disclosure, referring to FIG. 1, the user device (102) may include a user interface (108), a processing unit (110), a device memory (112), a skill assessment console (114) and a communication interface (116).

In some aspects, the user interface (108) may include an input interface for receiving inputs from the user. The input interface may be configured to fetch inputs, personal details of a number of users and/or one or more responses for a number of questions by the users. Examples of the input interface of the user interface (108) may include, but are not limited to, a touch interface, a mouse, a keyboard, a motion recognition unit, a gesture recognition unit, a voice recognition unit, or the like. Some aspects of the present disclosure are intended to include or otherwise cover any type of the input interface including known, related art, and/or later developed technologies. The user interface (108) may further include an output interface for displaying (or presenting) an output to the user. Examples of the output interface of the user interface (108) may include, but are not limited to, a digital display, an analog display, a touch screen display, a graphical user interface, a website, a webpage, a keyboard, a mouse, a light pen, an appearance of a desktop, and/or illuminated characters.

In some aspects, the processing unit (110) may include suitable logic, instructions, circuitry, interfaces, and/or codes for executing various operations, such as the operations associated with the user device (102), or the like. The processing unit (110) may be configured to control one or more operations executed by the user device (102) in response to the input received at the user interface (108) from the user. Examples of the processing unit (110) may include, but are not limited to, an application-specific integrated circuit (ASIC) processor, a reduced instruction set computing (RISC) processor, a complex instruction set computing (CISC) processor, a field-programmable gate array (FPGA), a Programmable Logic Control unit (PLC), and the like. Some aspects of the present disclosure are intended to include or otherwise cover any type of the processing unit (110) including known, related art, and/or later developed processing units.

In some aspects, the device memory (112) may be configured to store the logic, instructions, circuitry, interfaces, and/or codes of the processing unit (110), data associated with the user device (102), and data associated with the system (100). Examples of the device memory (112) may include, but are not limited to, a Read-Only Memory (ROM), a Random-Access Memory (RAM), a flash memory, a removable storage drive, a hard disk drive (HDD), a solid-state memory, a magnetic storage drive, a Programmable Read Only Memory (PROM), an Erasable PROM (EPROM), and/or an Electrically EPROM (EEPROM). Some aspects of the present disclosure are intended to include or otherwise cover any type of the device memory (112) including known, related art, and/or later developed memories.

In some aspects, the skill assessment console (114) may be configured as one or more computer-executable application, to be executed by the processing unit (112). The skill assessment console (114) may include suitable logic, instructions, and/or codes for executing various operations and may be controlled by the server (104). The one or more computer executable applications may be stored in the device memory (112). Examples of the one or more computer executable applications may include, but are not limited to, an audio application, a video application, a social media application, a navigation application, or the like.

In some aspects, the communication interface (116) may be configured to enable the user device (102) to communicate with the server (104) and other components of the system (100) over the communication network (106). Examples of the communication interface (116) may include, but are not limited to, a modem, a network interface such as an Ethernet card, a communication port, and/or a Personal Computer Memory Card International Association (PCMCIA) slot and card, an antenna, a radio frequency (RF) transceiver, one or more amplifiers, a tuner, one or more oscillators, a digital signal processor, a coder-decoder (CODEC) chipset, a subscriber identity module (SIM) card, and a local buffer circuit. It will be apparent to a person of ordinary skill in the art that the communication interface (116) may include any device and/or apparatus capable of providing wireless or wired communications between the user device (102) and the server (104) over the communication network (106).

The server (104) may be a network of computers, a software framework, or a combination thereof, that may provide a generalized approach to create the server implementation. Examples of the server (104) may include, but are not limited to, personal computers, laptops, mini-computers, mainframe computers, any non-transient and tangible machine that can execute a machine-readable code, cloud-based servers, distributed server networks, or a network of computer systems. The server (104) may be realized through various web-based technologies such as, but not limited to, a Java web-framework, a NET framework, a personal home page (PHP) framework, or any web-application framework. The server (104) may be maintained by a storage facility management authority or a third-party entity that facilitates service enablement and resource allocation operations of the system (100). The server (104) may include the processing circuitry (118) and one or more memory units (hereinafter, collectively referred to and designated as “Database”) (120).

In some aspects, the processing circuitry (118) may include suitable logic, instructions, circuitry, interfaces, and/or codes for executing various operations, such as user matching based on interests or the like. The processing circuitry (118) may be configured to host and enable the skill assessment console (114) running on (or installed on) the user device (102) to execute the operations associated with the system (100) by communicating one or more commands and/or instructions over the communication network (106). The processing circuitry (118) may be configured to perform a number of operations of the system (100). Examples of the processing circuitry (118) may include, but are not limited to, an ASIC processor, a RISC processor, a CISC processor, a FPGA, and the like.

In some aspects, the database (120) may be configured to store the logic, instructions, circuitry, interfaces, and/or codes of the processing circuitry (118) for executing a number of operations. The database (120) may be further configured to store therein, data associated with users registered with the system (100). Some aspects of the present disclosure are intended to include and/or otherwise cover any type of the data associated with the users registered with the system (100). Examples of the database (120) may include but are not limited to, a ROM, a RAM, a flash memory, a removable storage drive, a HDD, a solid-state memory, a magnetic storage drive, a PROM, an EPROM, and/or an EEPROM. In some aspects, a set of centralized or distributed network of peripheral memory devices may be interfaced with the server 104, as an example, on a cloud server.

The communication network (106) may include suitable logic, circuitry, and interfaces that may be configured to provide a number of network ports and a number of communication channels for transmission and reception of data related to operations of various entities (such as the user device (102) and the server (104)) of the system (100). Each network port may correspond to a virtual address (or a physical machine address) for transmission and reception of the communication data. For example, the virtual address may be an Internet Protocol Version 4 (IPV4) (or an IPV6 address) and the physical address may be a Media Access Control (MAC) address. The communication network (106) may be associated with an application layer for implementation of communication protocols based on one or more communication requests from the user device (102) and the server (104). The communication data may be transmitted or received, via the communication protocols. Examples of the communication protocols may include, but are not limited to, Hypertext Transfer Protocol (HTTP), File Transfer Protocol (FTP), Simple Mail Transfer Protocol (SMTP), Domain Network System (DNS) protocol, Common Management Interface Protocol (CMIP), Transmission Control Protocol and Internet Protocol (TCP/IP), User Datagram Protocol (UDP), Long Term. Evolution (LTE) communication protocols, or any combination thereof.

In some aspects of the present disclosure, the communication data may be transmitted or received via at least one communication channel of a number of communication channels in the communication network (106). The communication channels may include, but are not limited to, a wireless channel, a wired channel, a combination of wireless and wired channel thereof. The wireless or wired channel may be associated with a data standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a metropolitan area network (MAN), a satellite network, the Internet, an optical fiber network, a coaxial cable network, an infrared (IR) network, a radio frequency (RF) network, and a combination thereof. Aspects of the present disclosure are intended to include or otherwise cover any type of communication channel, including known, related art, and/or later developed technologies.

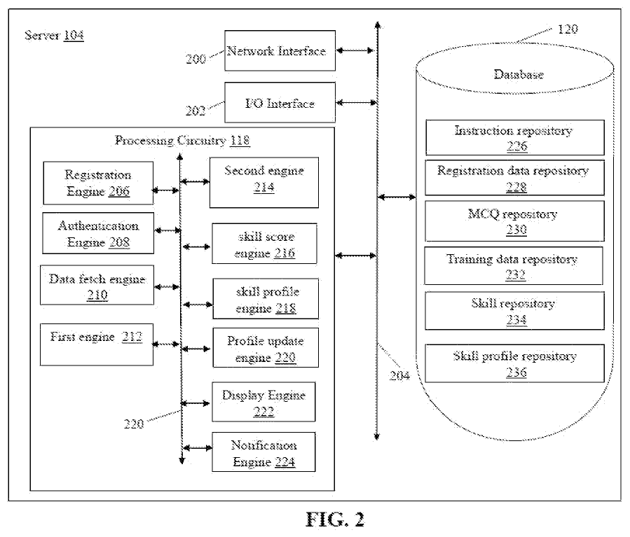

FIG. 2 is a block diagram that illustrates the server (104) of FIG. 1, in accordance with an exemplary aspect of the present disclosure. The server (104) may include the processing circuitry (118) and the database (120). The server (104) may further include a network interface (200) and an input/output (I/O) interface (202). The processing circuitry (118), the database (120), the network interface (200), and the input/output (I/O) interface (202) may be configured to communicate with each other by way of a first communication bus (204).

The processing circuitry (118) may include a registration engine (206), an authentication engine (208), a data fetch engine (210), a first engine (212), a second engine, a skill score engine (216), a skill profile engine (218), a profile update engine (220), a display engine (222), and a notification engine (224). It will be apparent to a person having ordinary skill in the art that the server (104) is for illustrative purposes and not limited to any specific combination of hardware circuitry and/or software.

The database (120) may include suitable logic, instructions, circuitry, interfaces, and/or codes to store data on the server (104), associated with a registered user. The network interface (200) may include suitable logic, circuitry, and interfaces that may be configured to establish and enable a communication between the server (104) and other components of the system (100), via the communication network (106). The network interface (200) may be implemented by use of various known technologies to support wired or wireless communication of the server (104) with the communication network (106). The network interface (200) may include, but is not limited to, an antenna a radio frequency (RF) transceiver, one or more amplifiers, a tuner, one or more oscillators, a digital signal processor, a coder-decoder (CODEC) chipset, a subscriber identity module (SIM) card, and a local buffer circuit.

The I/O interface (202) may include suitable logic, circuitry, interfaces, and/or code that may be configured to receive inputs (e.g., orders) and transmit server outputs via a number of data ports in the server (104). The I/O interface (202) may include various input and output data ports for different I/O devices. Examples of such I/O devices may include, but are not limited to, a touch screen, a keyboard, a mouse, a joystick, a projector audio output, a microphone, an image-capture device, a liquid crystal display (LCD) screen and/or a speaker.

In some aspects of the present disclosure, the system (100) may enable the user to input data by way of the user interface (110) of the user device (102). The database (122) may be configured to store the number of repositories, such that the number of repositories may store an instruction data by way of instruction repository (226), a user registration data by way of registration repository (228), a number of multiple choice questions (MCQs) by way of a MCQ repository (230), a training data for the first engine (212) and the second engine (214) by way of the training data repository (232), a set of pre-defined skills, a first set of skills and a skill taxonomy data or the like by way of a skill repository (234), and a skill profile data for a number of users of the system (100), by way of a skill profile repository (236). The training data may include but not limited to responses to a number of MCQs mapped to one or more skills from the set of pre-defined skills. In some aspects, the database may comprise a single repository, serving role of all the above mentioned repositories.

The term “first set of skills” is referred to as a set of selected skills from the set of pre-defined skills, by the user for skill taxonomy.

The term “skill taxonomy” is referred to as a pre-set classification of a number of pre-defined skills.

In some aspects of the present disclosure, the registration engine (206) may be configured to enable the users to register into the system (100) by providing registration data through a registration menu (not shown) of the skill assessment console (114) displayed through the user device (102). The registration data may include, but is not limited to, personal details of the user such as name, age, photograph, sex, qualifications, expertise, verification ID, email ID or the like.

In some aspects of the present disclosure, the registration engine (206) may be configured to face match the photograph taken with a phone camera (not shown) initially with a camera preview background snapshot. The registration engine (206) may be configured to utilize a facial recognition and/or a face matching algorithm to match the photographs uploaded by the user. Further, the registration engine (206) may be configured to utilize a motion verification technique such that the registration engine (206) generates random motions to be detected via the phone camera preview and verify an authenticity of the user.

In another aspect, the device memory (112) may be configured to temporarily store the personal data obtained from the user by way of user interface (110), before registration and authentication of the user. The authentication engine (208) may be configured to fetch personal registration data provided by the user from the device memory (112) and authenticate the user's profile based on the comparison and verification of information provided by the user. Upon successful authentication of the user, the notification engine (224) may be configured to generate a successful authentication notification that may be displayed through the registration menu as a pop-up notification. The notification engine (224) may further be configured to generate a failed authentication notification as a pop-up upon failed authentication by the authentication engine (208). The notification may be displayed through the output interface by way of the display engine (222).

In some aspects, a number of engines of the processing circuitry (118) may require data to be fetched from one or more repositories of the database (120). The data from one or more repositories to be used by the number of engines of the processing circuitry (118) may be fetched by way of the data fetch engine (210). Further, the data fetch engine (210) (hereinafter interchangeably referred to as “fetch engine”) may be configured to fetch the set of pre-defined skills from the skill repository. In another aspect of the present disclosure, the system (100) may include a single repository unit containing a number of data possessed by the database (120).

In some aspects, the first engine (212) may be configured to fetch a first set of MCQs from the MCQ repository (230) by way of the fetch engine (210). A number of users may be required to train the first engine (212) by way of a number of responses to a number of MCQs fetched from the MCQ repository (230). The user may be required to submit responses to the first set of the MCQs by way of user interface (108). The first engine (212) may further be configured to map the responses to the first set of MCQs with the training responses fetched from the training data repository (232), using one or more machine learning techniques to obtain a first normalized skill proficiency score vector (hereinafter interchangeably referred to as “first score vector”). The first score vector may indicate the proficiency of skills analyzed through the responses to the first set of MCQs by the user. In an aspect, the first engine (212) may use a dense feed forward neural network to obtain the first score vector.

In some aspects, the system (100), by way of the skill score engine (216), may be configured to generate a first normalized skill score (herein after interchangeably referred to as “first skill score”). The skill score engine (216) may use one or more approaches of artificial intelligence (AI) such as normalized weighted sum of the first score vector or the like to generate the first skill score.

The second engine (214), may include one or more machine learning techniques to obtain correlation and inter-dependence between the skills, by way of the multi-tier skill taxonomy. Further, based on the first skill score for the user, the correlation and interdependence between the skills and the multi-tier skill taxonomy, the second engine (234) may be configured to map the first score vector to the skill taxonomy to create a job profile based on the skill score of the user. Further, the second engine (214) max fetch the multi-tier skill taxonomy from the skill repository (234). In some aspects, the second engine (214) may use sparsely connected feed forward neural network to obtain correlation and inter-dependence between the skills and mapping the first score vector to the multi-tier taxonomy.

In some aspects, the skill profile engine (218) may be configured to generate a skill profile for the user. The skill profile may include but not limited to personal details provided by the user, by way of user interface (110), such as the name, the age, the photograph, the sex, the qualifications, the expertise, the verification ID, the email ID, and the first skill vector and the first skill score for the user.

In some aspects, the user may be required to select a first set of skills from the predefined skills by way of the user interface (108). Further, the second engine may generate a first skill vector for the first set of skills. Furthermore, based on the first skill vector for the first set of skills, the system (100) may be configured to generate the first skill score.

In some aspects, the user may update the skill profile by way of a second normalized skill score (hereinafter interchangeably referred to as “second skill score”) through a second skill profiling by the system (100). The user may further be required to respond to a second set of MCQs fetched from the MCQ repository (230). The processing circuitry (118) may further be configured to generate a second normalized skill proficiency score vector (hereinafter interchangeably referred to as “second score vector”). by way of the second engine (214). The system (100) may be configured to obtain the second skill score using the second score vector by way of one or more AI based approaches. Further, the skill profile of the user may be updated based on the second score vector and the second skill score.

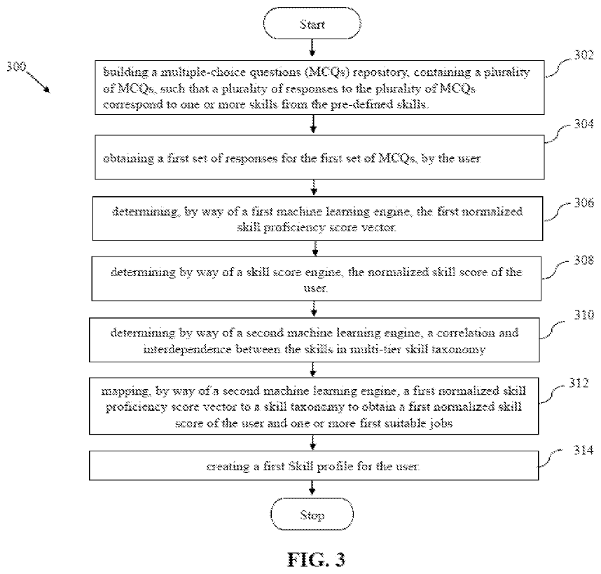

FIG. 3 illustrates a flowchart for a method (300) for skill profiling of the user, according to an aspect herein.

At step (302), the system (100) may be configured to build the MCQ repository (230) containing a number of MCQs, such that a number of responses to the number of MCQs correspond to one or more skills from the pre-defined of skills. Further, the system (100) may facilitate the user to select the first set of skills from the pre-defined skills. Furthermore, based on the selected first set of skills, the system (100) may be configured to deliver/present a skill assessment test including the first set of MCQs of the number of MCQs from the MCQ repository (230).

At step (304), the system (100) may be configured to obtain first set of responses for the first set of MCQs from the user.

At step (304), the system (100) may be configured to determine, by way of the first engine (212), the first score vector.

At step (306), the system (100) may be configured to determining by way of a skill score engine (216), the skill score of the user.

At step (308), the system (100) may be configured to determine by way of a second engine (214), a correlation and inter-dependence between the skills in multi-tier skill taxonomy.

At step (310), the system (100) may be configured to map, by way of a second engine (214), a first score vector to the multi-tier skill taxonomy to obtain the first skill score of the user and one or more first suitable jobs.

At step (312), the system (100) may be configured to create the first skill profile for the user.

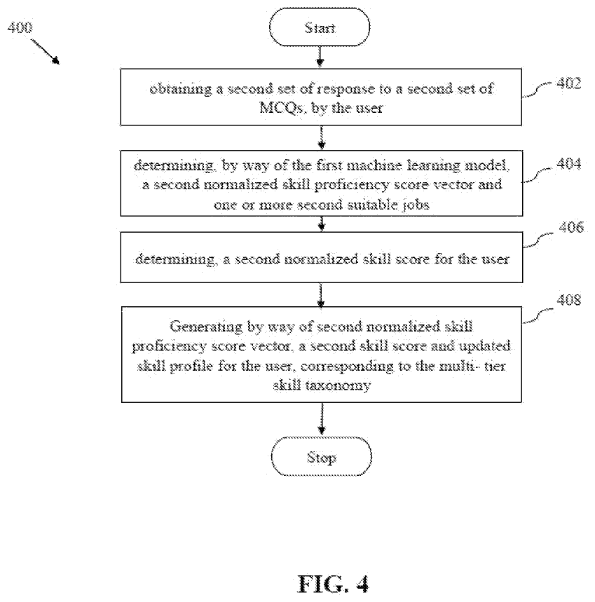

FIG. 4 illustrates a flowchart (400) of for updating the first skill score and first skill profile of the user, according to an aspect herein.

At step (402), the system (100) may be configured to facilitate a user with the second set of MCQs. The user may further be required to respond to the second set of MCQs. The system (100) may be configured to obtain a second set of response to a second set of MCQs, by the user.

At step (404), the system (100) may be configured to determine, by way of the first engine (212), a second normalized skill proficiency score vector (hereinafter interchangeably referred to as “second score vector”) and one or more second suitable jobs.

At step (406), the system (100), may utilize the second score vector, and by way of the skill score engine (216), may be configured to generate a second skill score. The skill score engine (216) may use one or more approaches of artificial intelligence (AI) such as normalized weighted sum of the first score vector or the like to generate the second skill score.

At step (408), the system (100) may be configured to generate, by way of second score vector, a second skill score and an updated skill profile for the user, corresponding to the multi-tier skill taxonomy.

Thus, the system (100), may facilitate one or more users with a skill profiling based on the multi-tier skill taxonomy. The system (100) may further facilitate one or more users to select one or more skills from a number of pre-defined skills for assessment. Furthermore, the system (100) may be configured to discover skills by assessing a number of responses to a number of MCQs by way of the first score vector. Furthermore, the system (100) may be configured to determine inter-dependence and correlation between a selected set of skills and map the correlation and inter-dependence of the selected set of skills to the multi-tier skill taxonomy to obtain a skill score for one or more users. Furthermore, the system (100) may be configured to generate and/or display one or more skill profiles for each user of the system (100).

As will be readily apparent to those skilled in the art, the present embodiment may easily be produced in other specific forms without departing from its essential characteristics. The present embodiment are, therefore, to be considered as merely illustrative and not restrictive, the scope being indicated by the claims rather than the foregoing description, and all changes which come within therefore intended to be embraced therein. As one skilled in the art will appreciate, the system (100) includes a number of engines such that, the number of engines go beyond merely finding one or more computer algorithms to carry out one or more procedures and/or methods in the form of a predefined sequential manner, adding up the overall functionality of the system (100). Hence all the steps, methods and/or procedures of the system (100) are generic and procedural in nature.

Certain terms are used throughout the following description and claims to refer to particular features or components. As one skilled in the art will appreciate, different persons may refer to the same feature or component by different names. This document does not intend to distinguish between components or features that differ in name but not structure or function. While various aspects of the present disclosure have been illustrated and described, it will be clear that the present disclosure is not limited to these aspects only. Numerous modifications, changes, variations, substitutions, and equivalents will be apparent to those skilled in the art, without departing from the spirit and scope of the present disclosure, as described in the claims.

We claim(s):

1. A method (300) for skill profiling, comprising:
obtaining a first normalized skill proficiency score vector for a user by way of a first engine (212);
mapping the first normalized skill proficiency score vector with a pre-set multi-tier skill taxonomy, by way of a second engine (214);
obtaining a first normalized skill score for the user by way of a first skill score engine (216); and
generating a first skill profile of the user by way of a skill profile engine (218).

2. The method as claimed in claim 1, further comprising:
creating, prior to obtaining the first normalized skill proficiency score vector, a multiple-choice question (MCQ) repository (230) having a plurality of multiple-choice questions (MCQs) such that a plurality of multiple-choice question (MCQ) responses corresponds to one or more skills of set of predefined skills stored in a skill repository (234).

3. The method as claimed in claim 2, further comprising
determining, prior to mapping the first normalized skill proficiency score vector with the pre-set multi-tier skill taxonomy, a correlation matrix and an inter-dependence matrix for the one or more skills of the set of predefined skills; and
mapping a plurality of MCQ responses with the one or more skills of the set of predefined skills in accordance with the multi-tier skill taxonomy.

4. The method as claimed in claim 1, wherein for obtaining the first normalized skill proficiency score vector, the method further comprising:
obtaining a first set of MCQ responses for a first set of MCQs from the user by way of a user device (102); and
analyzing the first set of MCQ responses, to obtain the first normalized skill proficiency score vector for a first set of skills of the user.

5. The method as claimed in claim 4, determining, by way of the second engine (214), one or more first job profiles and a plurality of job positions for the user, based on the first normalized skill proficiency score vector.

6. The method as claimed in claim 1, wherein the first engine (212) is based on dense feed forward neural network.

7. The method as claimed in claim 1, wherein the second engine (214) is based on sparsely connected feed forward neural network.

8. The method as claimed in claim 1, further comprising obtaining the first normalized skill score by normalized weighted sum of the first normalized skill proficiency score vector.

9. The method as claimed in claim 1, further comprising generating a second skill profile associated with the user, through update in the first skill profile of the user, by way of a profile update engine (220).

10. A skill profiling system (100), comprising:
a user device (102), configured to (i) receive a plurality of multiple-choice question (MCQ) responses of a plurality of multiple-choice questions (MCQ's) from the user and (ii) display the first skill profile of the user based on the MCQ responses; and
a server (104) coupled to the user device (102), wherein the server (104) is configured to:
obtain a first normalized skill proficiency score vector for a user by way of a first engine (212);
map the first normalized skill proficiency score vector with a pre-set multi-tier skill taxonomy, by way of a second engine (214);
obtain a first normalized skill score for the user by way of a first skill score engine (216); and
generate a first skill profile of the user by way of a skill profile engine (218).

11. The skill profiling system (100) as claimed in claim 10, wherein the server (104) comprising a multiple-choice question (MCQ) repository (230) having a plurality of multiple-choice questions (MCQs) such that a plurality of multiple-choice question (MCQ) responses corresponds to one or more skills of set of predefined skills stored in a skill repository (234).

12. The skill profiling system (100) as claimed in claim 10, wherein the server (104) is further configured to:
create, prior to obtaining the first normalized skill proficiency score vector, a multiple-choice question (MCQ) repository having a plurality of multiple-choice questions (MCQs) such that a plurality of multiple-choice question (MCQ) responses corresponds to one or more skills of set of predefined skills stored in a skill repository (234).

13. The skill profiling system (100) as claimed in claim 10, wherein the server (104) is further configured to:
determine, prior to mapping the first normalized skill proficiency score vector with the pre-set multi-tier skill taxonomy, a correlation matrix and an inter-dependence matrix for the one or more skills of the set of predefined skills; and
map a plurality of MCQ responses with the one or more skills of the set of predefined skills in accordance with the multi-tier skill taxonomy.

14. The skill profiling system (100) as claimed in claim 10, wherein the server (104) is further configured to determine, by way of the second engine (214), one or more first job profiles s and a plurality of job positions for the user, based on the first normalized skill proficiency score vector.

15. The skill profiling system (100) as claimed in claim 10, further comprising a database (204) coupled to the server (104) such that the database (204) comprises a registration data repository (228), a multiple-choice question repository (230), a training data repository (232), a skill repository (234), and a skill profile repository (236).

16. The skill profiling system (100) as claimed in claim 10, the multiple-choice question repository (230) is configured to store a plurality of multiple-choice questions.

17. The skill profiling system (100) as claimed in claim 8, wherein the training data repository (232) is configured to store a training data for the first engine and the second engine.

18. The skill profiling system (100) as claimed in claim 8, wherein the skill repository (234) is configured to store a set of pre-defined skills, a first set of skills and a skill taxonomy data.

19. The skill profiling system (100) as claimed in claim 8, wherein the skill profile repository (236) is configured to store and display one or more skill profiles for a plurality of users.
